(19) United States
(12) Patent Application Publication
(10) Pub. No.: US 2004/0035017 A1
(43) Pub. Date: Feb. 26, 2004

(54) Second brake of measuring tape

(76) Inventor: Ching-Chun Yang, Taipei Hsien (TW)

Correspondence Address: RABIN & BERDO, P.C., Suite 500, 1101 14 Street, N.W., Washington, DC, 20005, US

(21) Appl. No.: 10/225,176

(22) Filed: Aug. 22, 2002

(51) Int. Cl. G01B 3/10

(52) U.S. Cl. 33/767

(57) ABSTRACT

A second brake of a measuring tape includes an outer casing assembled by upper and lower casings, a wheel ring, two sides of the wheel rim inside the casing are respectively disposed with a toothed ring; the lower aspects of the upper and lower casings are disposed respectively with a through hole for inserting a bottom brake tab therein; two sides of the bottom brake tab are disposed with convex positioning tooth pieces. Pushing a press button on the bottom brake tab makes the positioning tooth piece mesh and position toward the wheel rim; releasing the brake makes the measuring tape resume the original position thereby facilitating the measuring application.

### BACKGROUND OF THE INVENTION

1) Field of the Invention

The present invention relates to a second brake of a measuring tape, more particularly to a temporary brake device on a measuring tape which mainly comprises a bottom brake tab disposed at a most proper bottom portion of the measuring tape and has the feature of a gear mesh. Pushing the bottom brake tab meshes a positioning tooth piece and a wheel rim thereon to brake temporarily thereby preventing easily pushing and moving a rule tape laterally or axially; releasing the bottom brake tab makes the measuring tape resume the original status thereby facilitating the measurement.

2) Description of the Prior Art

Accordingly, since a measuring tape is convenient for carrying and application, it has been popularly used for measurement jobs. However, the greatest disadvantage of using a measuring tape is the occurrence of error during the measurement. For example, when trying to use the measuring tape as a tool to obtain a proper length on a wall, it is hard to realize how long the rule tape has been pulled out. Usually people push a conventional friction-type brake for checking the length. If it is too short, the brake is twisted back for continuously pulling more rule tape. However, repetitively pushing the conventional brake for temporary pause has the following shortcomings in measurement:

1. At the moment of using a wedge friction block to fixedly push from one side of the rule tape might deviate the rule tape toward one side.

2. Repetitively using the fingers to laterally push the frictional brake back and forth while pulling the measuring tape to measure might easily cause the fingers to shake. That not only affects the precision of measurement, but also exerts more force and is not convenient for application.

3. Blocking the rotation of the rule tape through friction is not very effective. Frequently and unintentionally pressing the end portion of the rule tape might press back or pull the rule tape for a certain distance thereby causing length misjudgment.

### SUMMARY OF THE INVENTION

Therefore, the primary objective of the present invention is to design a temporary brake for a measuring tape by mainly disposing a bottom brake tab on the bottom portion thereof and a positioning tooth piece thereon. Pushing and pressing the positioning tooth piece to directly mesh with a toothed ring on a wheel rim stops the movement of the rule tape and makes the mesh very steady and specific. Releasing the bottom brake piece makes the measuring tape resume the original status. It is merely necessary to use the finger to directly press and release the bottom brake tab for rewinding and stretching the rule tape. That is a more convenient application and the main feature of the present invention.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is an exploded drawing of the structure of the present invention.

FIG. 2 is a drawing of the assembled present invention.

FIG. 3 is a cross-sectional drawing of the present invention.

FIG. 4 is a drawing of the movement of the present invention.

### DETAILED DESCRIPTION OF THE PREFERRED EMBODIMENTS

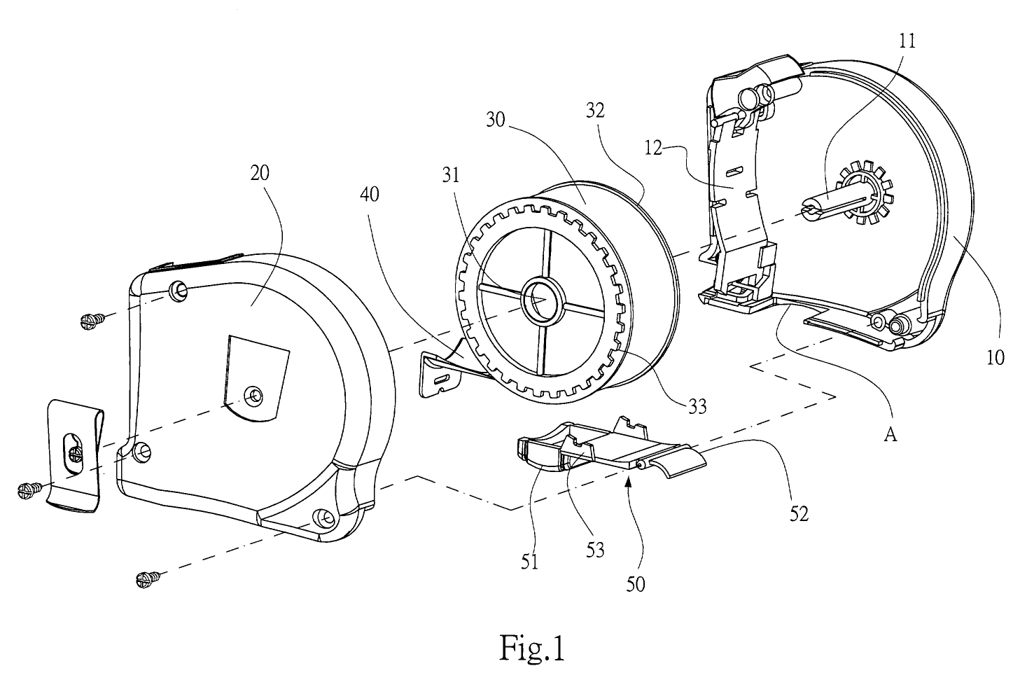

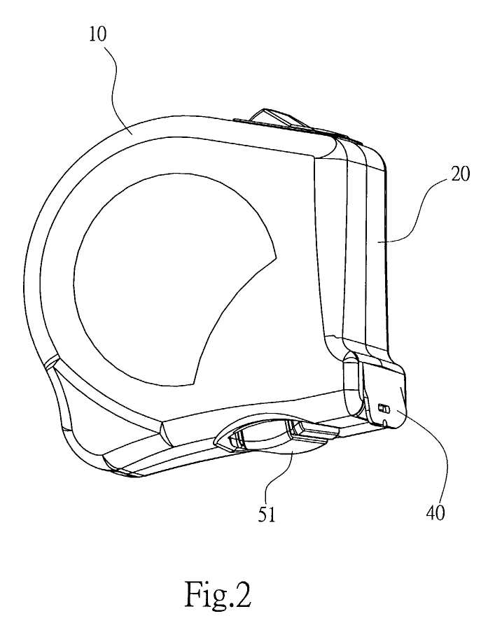

Referring to FIGS. 1 and 2, the present invention mainly comprises an upper casing (10), a lower cashing (20) and a central wheel rim (30); wherein a conventional brake (12) is disposed on one side of the upper casing (10), a shaft rod (11) is disposed at the center thereof and a through hole (A) is disposed respectively and oppositely at the lower aspects of the upper and the lower casings (10, 20); the engagement of the upper casing (10) and the lower casing (20) forms an outer casing of the measuring tape.

The center of the wheel rim (30) is disposed with a shaft hole (31) and the peripheral side thereof is concavely disposed with an annular groove (32). The wheel rim (30) is inserted onto the shaft rod (11) of the upper casing (10); the rule tape (40) coils on the annular groove (32); wherein two sides of the wheel rim (30) are respectively and convexly disposed with a toothed ring (33).

One end of the bottom brake tab (50) is formed into a convex press button (51) and the other end thereof is disposed with a resilient branch shaft (52). A positioning tooth piece (53) is respectively disposed on two sides of the center; the bottom brake tab (50) is disposed on the inner rim of the through hole (A) formed by the engaged upper and the lower casings (10, 20) with the press button (51) protruding outside the through hole (A).

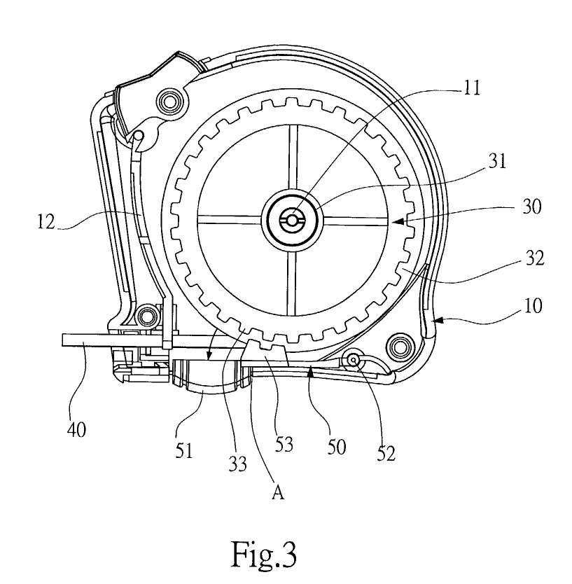

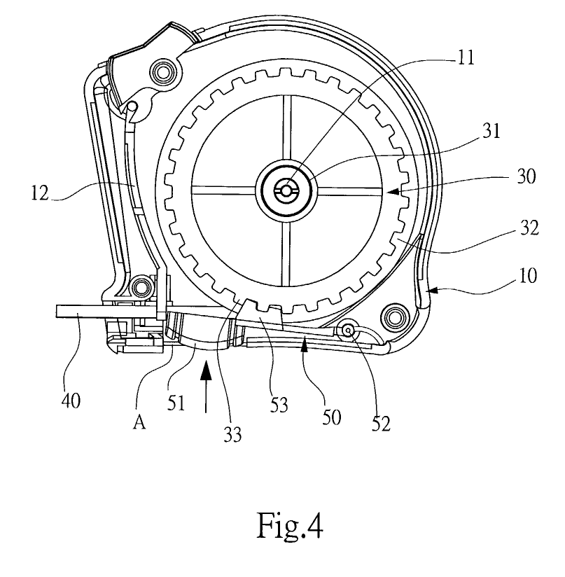

Referring to FIGS. 1, 3 and 4, pushing the press button (51) of the bottom brake tab (50) pushes the positioning tooth piece (53) toward the toothed ring (33) area of the wheel rim (30). At this time, the positioning tooth piece (53) fitly meshes the toothed ring (33) and is not able to move even though the rule tape (40) is touched by an external force. Furthermore, the toothed brake (50) is not subject to spin thereby the tightness thereof is very good. When being released, the bottom brake tab (50) resumes the original position through the resilient branch shaft (52) to separate the positioning tooth piece (53) and the wheel rim (30) thereby allowing the wheel rim (30) to rotate again.

With special design, when applying the present invention, the positioning between the bottom brake tab (50) and the wheel rim (30) is not only specific but also stable since it is accomplished through a gear-type positioning method. Once it is locked, it won't easily rotate due to an unintentional and lateral push. That is the major advantage of the present invention.

Furthermore, the present invention has the bottom brake tab (50) disposed on the bottom portion of the measuring tape. It is merely necessary to use the fingers to press and release the bottom brake tab (50) once for achieving the objective of rewinding and releasing the rule tape. The application thereof is very convenient, requires easy force exertion and indirectly makes the measurement more convenient and precise. That is another advantage of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A second brake of a measuring tape mainly comprising an outer casing of a measuring tape fitly assembled by two engaged upper casing and lower casings, a traditional brake structure disposed on one side thereof, a shaft rod disposed at the center thereof with a wheel rim disposed thereon and a rule tape coiled around the peripheral side of the wheel rim is characterized that:
a toothed ring is respectively and convexly disposed on two sides of the wheel rim;
through holes are respectively and oppositely disposed at the lower aspects of the upper and the lower casings;
one end of a bottom brake tab is formed as a convex press button; the other end thereof is disposed with a resilient branch shaft; wherein at least one side thereof is disposed with a positioning tooth piece; the bottom brake tab is disposed on the inner rim of the fitly engaged upper and lower casings with a press bottom protruding outside the through hole; pushing the press button of the bottom brake tab makes the positioning tooth piece mesh and position toward the wheel rim; releasing the brake makes the measuring tape resume the original status.
